(19) United States
(12) Patent Application Publication
(10) Pub. No.: US 2003/0021277 A1
(43) Pub. Date: Jan. 30, 2003

(54) Physical layer duplicating apparatus and method of ATM exchange

(75) Inventors: Jae Uk Eum, Kyungki-Do (KR); Jong Cheon Kim, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 10/207,165

(22) Filed: Jul. 30, 2002

(30) Foreign Application Priority Data
Jul. 30, 2001 (KR) 45903/2001

(51) Int. Cl. H04L 12/28; H04L 12/40

(52) U.S. Cl. 370/395.1; 370/438

(57) ABSTRACT

A physical layer duplicating apparatus and method of an ATM exchange are disclosed. A multiple interface module is provided to interface a cell transmission between duplicated physical layers and an ATM layer board, so that a single corresponding interface specification pursued by the UTOPIA bus is satisfied and several physical layer boards can be accommodated in a series of communication cycle.

### BACKGROUND OF THE INVENTION

1. Field of the Invention

The present invention relates to an ATM exchange, and more particularly, to a physical layer duplicating apparatus and method of an ATM exchange.

2. Description of the Background Art

In general, devices on an ATM layer board and a physical layer board transmits/receives an ATM cell through a universal test and operation PHY interface for ATM (UTOPIA) interface.

Defined in an ATM Forum standard specification, the UTOPIA interface is a single corresponding type interface module implemented on the basis of a technical specification of 1:1 communication between the ATM layer board and the physical layer board, and includes a UTOPIA bus.

FIG. 1 is a drawing illustrating a UTOPIA interface unit of an ATM exchange in accordance with a conventional art.

As shown in FIG. 1, the conventional UTOPIA interface unit includes: an ATM layer board 1, a physical layer board 2 and a UTOPIA bus 3 for interfacing the two layer boards 1 and 2.

The ATM layer board performs a master function on the UTOPIA bus 3 while the physical layer board 2 performs a slave function on the UTOPIA bus 3.

A series of cells outputted from the ATM layer board 1 is transmitted to the physical layer board 2 through the UTOPIA bus 3, and a physical layer processing device of the physical layer board 2 performs a physical layer interfacing on the received cells and transmits them to a subscriber terminal 5 through a cable 4. At this time, as shown in FIGS. 1A and 1B, there can be provided one or plural physical layer processing devices, which will handle the physical layer processing.

The cell transmitted from the subscriber terminal 5 through the cable 4 is processed by the physical layer device 2-1 of the physical layer board 2 and transmitted to an ATM layer board 1 through the UTOPIA bus 3.

As mentioned above, in the conventional UTOPIA interface unit, the cell transmission and reception interfacing between the ATM layer board and the physical layer is performed by the UTOPIA interface. In this respect, however, since the UTOPIA interface, that is, the UTOPIA bus, is the single corresponding type interface module implemented with a specification of 1:1 communication between the ATM layer board and the physical layer board, the ATM layer board has no choice but to process independently only the cells transmitted from one physical layer board.

Resultantly, owing to the 1:1 interface characteristics of the UTOPIA bus, the UTOPIA interface unit is not able to accommodate a duplicated physical layer processing board, and especially, it has a problem that it can only one physical layer board in a series of communication cycle.

In addition, since the conventional UTOPIA interface unit accommodates only one physical layer board, if there occurs an error in the physical layer board, a communication service between the ATM layer board and the subscriber terminal is discontinued.

In such a case, the subscriber couldn't receive a desired communication service smoothly, and if such a situation repeatedly occurs, an overall system performance of the ATM exchange adopting the UTOPIA interface is degraded.

The above references are incorporated by reference herein where appropriate for appropriate teachings of additional or alternative details, features and/or technical background.

### SUMMARY OF THE INVENTION

Therefore, an object of the present invention is to provide a physical layer duplicating apparatus and method of an ATM exchange that are capable of providing a duplicated physical layer board.

Another object of the present invention is to provide a physical layer duplicating apparatus and method that are capable of accommodating several physical layer boards in a series of communication cycle.

Still another object of the present invention is to provide a physical layer duplicating apparatus and method of an ATM exchange that are capable of improving a reliability of an ATM exchange by providing a duplicated physical layer board.

To achieve at least the above objects in whole or in parts, there is provided a physical layer duplicating apparatus of an ATM exchange including: first and second physical layer boards connected to a subscriber terminal; an ATM layer board; and a multiple interface module for interfacing a cell transmission between the ATM layer board and first and second physical layer boards.

To achieve at least these advantages in whole or in parts, there is further provided a physical layer duplicating apparatus of an ATM exchange including: first and second physical layer boards connected to a subscriber terminal; an ATM layer board; and a multiple interface module for interfacing a cell transmission between the ATM layer board and first and second physical layer board through an independent UTOPIA bus; wherein the multiple interface module including: a duplicating controller for receiving a status signal from first and second physical layer boards and outputting a board select signal to select an optimum physical layer board; and a multiple interface unit for selectively transmitting a cell transmitted from first and second physical layer boards to the ATM layer board according to the board select signal.

To achieve at least these advantages in whole or in parts, there is further provided a physical layer duplicating method of an ATM exchange of a physical layer duplicating apparatus of the ATM exchange having a multiple interface module connected between an ATM layer board and first and second physical layer board through a UTOPIA bus, including the steps of: receiving a cell from the ATM layer board through first UTOPIA bus and transmitting the cell to first and second physical layer boards through second and third UTOPIA buses; and receiving cells from the first and second physical layer boards through the second and third UTOPIA buses and selectively transmitting them to the ATM layer board according to the state of the first and second physical layer boards.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIGS. 1A and 1B are UTOPIA interface units of an ATM exchange in accordance with a conventional art;

FIG. 2 is a drawing illustrating a physical layer duplicating apparatus of an ATM exchange in accordance with a first embodiment of the present invention;

FIG. 3 is a drawing illustrating a detailed construction of the physical layer duplicating apparatus of an ATM exchange of FIG. 2 in accordance with the first embodiment of the present invention;

FIG. 4 is a drawing illustrating a detailed construction of a multiple interface unit of FIG. 3 in accordance with the first embodiment of the present invention;

FIG. 5 is a drawing illustrating a physical layer duplicating apparatus of an ATM exchange in accordance with a second embodiment of the present invention;

FIG. 6 is a drawing illustrating a physical layer duplicating apparatus of an ATM exchange in accordance with a third embodiment of the present invention; and

FIG. 7 is a drawing illustrating a detailed construction of a multiple interface unit of FIG. 6 in accordance with the third embodiment of the present invention.

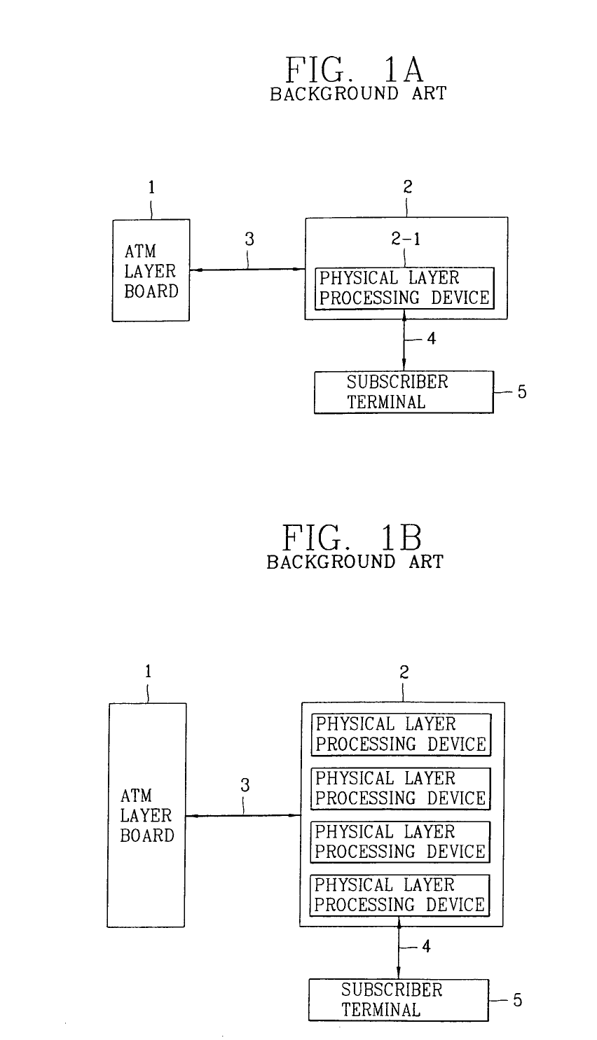

### DETAILED DESCRIPTION OF THE PREFERRED EMBODIMENTS

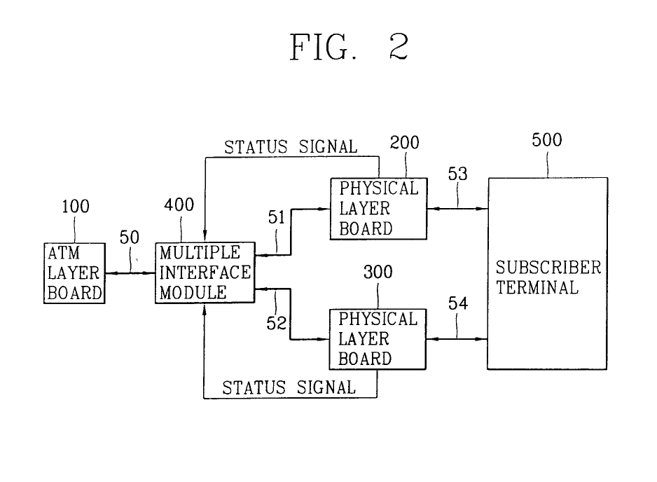

FIG. 2 is a drawing illustrating a physical layer duplicating apparatus of an ATM exchange in accordance with a first embodiment of the present invention;

As shown in FIG. 2, a physical layer duplicating apparatus of an ATM exchange in accordance with a first embodiment of the present invention includes: an ATM layer board 100; two physical layer boards 200 and 300; and a multiple interface module 400 for interfacing a cell transmission between the ATM layer board 100 and the physical layers 200 and 300 through UTOPIA buses 50-52.

The physical layer boards 200 and 300 are connected to a subscriber terminal 500 through cables 53 and 54.

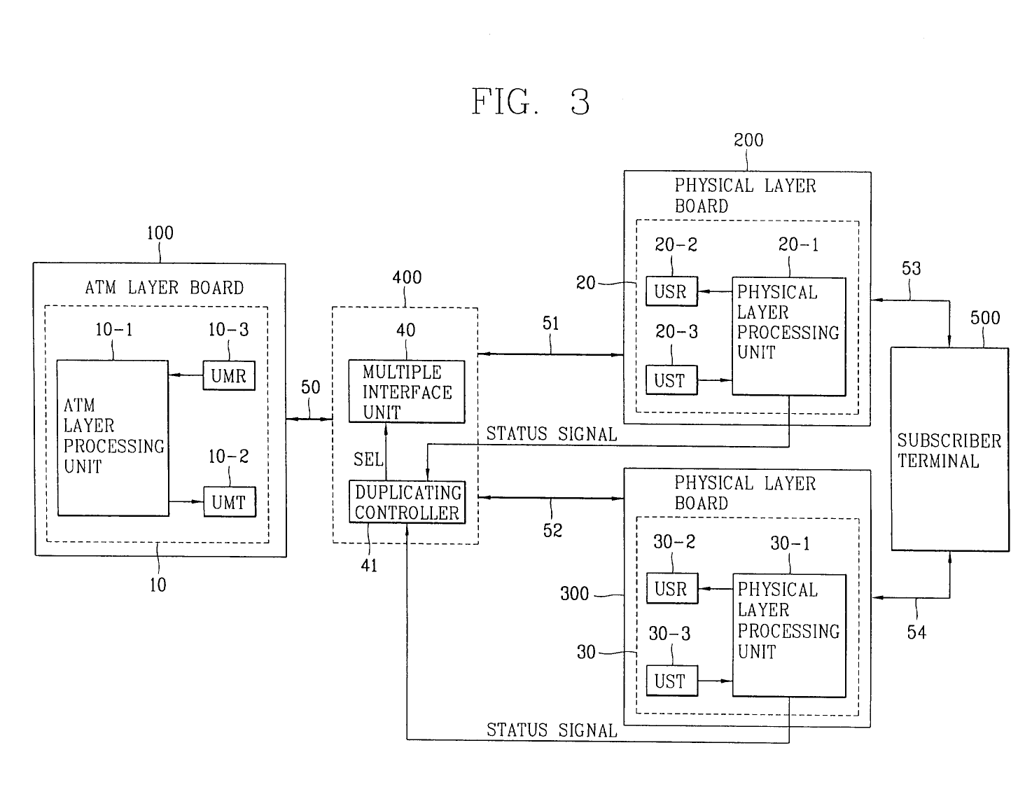

FIG. 3 is a drawing illustrating a detailed construction of the physical layer duplicating apparatus of an ATM exchange of FIG. 2 in accordance with the first embodiment of the present invention.

As shown in FIG. 3, the ATM layer board 100 includes an ATM layer processing device 10. The ATM layer device 10 includes: an ATM layer processing unit 10-1 for processing an inherent function of the ATM layer such as a cell header conversion and a user parameter monitoring; a UTOPIA master transmission unit (UMT) 10-2 for transmitting a cell processed in the ATM layer processing unit 10-1 to the multiple interface module 400 through the UTOPIA bus; and a UTOPIA master receipt unit (UMR) 10-3 for outputting the cell received through the multiple interface module 400, to the ATM layer processing unit 10-1.

The physical layer board 200 includes a physical layer device 20 consisting of a physical layer processing unit 20-1 for processing an inherent function of a physical layer such as a physical layer interfacing agreed with a subscriber and a cell extracting; a UTOPIA slave receipt (USR) unit 20-2 for receiving a cell from the physical layer processing unit 20-1 and transmitting the cell to the multiple interface module 400; and a UTOPIA slave transmission (UST) unit 20-3 for outputting the cell received through the multiple interface module 400 to the physical layer processing unit 20-1.

The physical layer board 300 have the same construction with the physical layer board 200, of which descriptions are thus omitted.

The multiple interface module 400 includes: a multiple interface unit 40 for interfacing a cell transmission between the ATM layer board 100 and the physical layer board 200 or between the ATM layer board 100 and the physical layer board 300 according to a board select signal (SEL); and a duplicating controller 41 for receiving status signals from the physical layer boards 200 and 300 and selecting an optimum physical layer board.

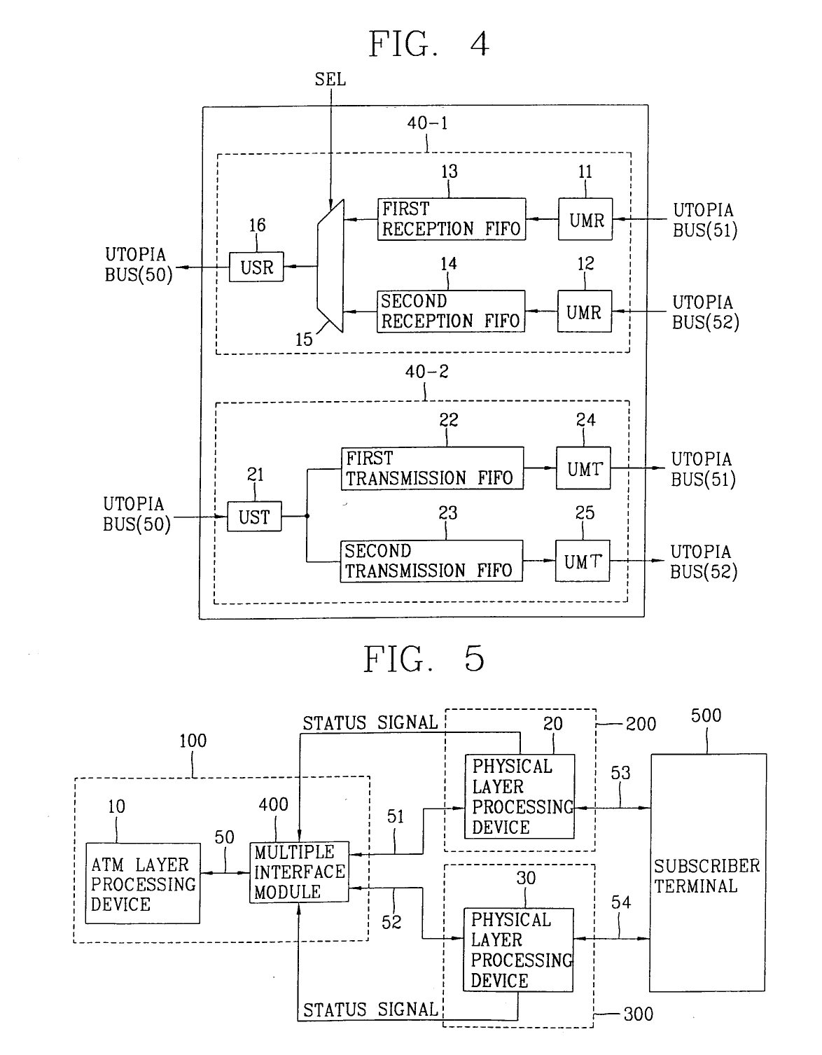

FIG. 4 is a drawing illustrating a detailed construction of the multiple interface unit 40.

As shown in FIG. 4, the multiple interface unit 40 includes: a reception cell interface unit 40-1 for selectively outputting cells received from the physical layer boards 200 and 300 to the ATM layer board 100 according to a board select signal (SEL); and a transmission cell interface unit 40-2 for outputting a cell received from the ATM layer board 100 to the physical layer boards 200 and 300.

The reception cell interface unit 40-1 includes: first and second UMRs 11 and 12 for receiving cells transmitted from the physical layer boards through the UTOPIA buses 51 and 52; first and second reception first-in first-out (FIFOs) 13 and 14 for receiving the reception cells of first and second UMRs 11 and 12; a multiplexer 15 for selectively outputting the stored cells of first and second reception FIFOs 13 and 14 according to the board select signal (SEL); and a USR 16 for outputting the cell outputted from the multiplexer 15 to the ATM layer board 100 through the UTOPIA bus 50.

The transmission cell interface unit 40-2 includes: a UST 21 for receiving a cell transmitted from the ATM layer board 100 through the UTOPIA bus 50; first and second transmission FIFOs 22 and 23 for storing the reception cell of the UST 21; and first and second UMT 24 and 25 for respectively transmitting the cells stored in the first and second transmission FIFOs 22 and 23 to the physical layer boards 200 and 300 through the UTOPIA buses 51 and 52.

The operation of the physical layer duplicating apparatus of an ATM exchange constructed as described above will now be explained with reference to the accompanying drawings.

As shown in FIG. 2, in the present invention, two physical layer boards 200 and 300 interwork with the ATM layer board 100 through different UTOPIA buses 51 and 52, and the transmission/reception interface through the UTOPIA buses 50-52 can be performed by the multiple interface module 400.

Accordingly, the multiple interface module 400 transmits the cell received from the ATM layer board through the UTOPIA bus 50 equally to the physical layer boards 200 and 300 through the UTOPIA buses 51 and 52, and transmits received from the physical layer boards 200 and 300 through the UTOPIA buses 51 and 52 selectively to the ATM layer board 100 through the UTOPIA bus 50.

At this time, the multiple interface module 400 receives board status signals from the physical layer boards 200 and 300, selects a cell received from the physical layer board 200 or 300 in a normal state and outputs the selected cell to the ATM layer board 100.

Therefore, in the present invention, for example, if there occurs a trouble in the physical layer board 200, cell transmission/reception is normally performed through the physical layer 300, so that a quality of the communication service and a reliability of an overall ATM exchange can be heightened.

The operation will now be described in detail with reference to FIGS. 3 and 4.

The multiple interface module 400 performs a 1:1 cell transmission/reception with the ATM layer board 100 through the UTOPIA bus 50. At this time, the ATM layer board 100 performs a master function of the UTOPIA bus 50 and the multiple interface module 400 performs a slave function.

1) Cell Transmission from the ATM Layer Board to the Physical Layer Board

The ATM layer processing unit 10-1 of the ATM layer board informs the UMT 10-2 that there is a cell to be transmitted. Then, the UMT 10-2 inquires of the multiple interface unit 40 of the multiple interface module 400 through the UTOPIA bus 50 as to whether it can receive a cell.

As shown in FIG. 4, the UST 21 of the transmission cell interface unit 40-2 of the multiple interface unit 40 checks the states of the first and second transmission FIFOs 22 and 23 and informs the UMT 10-2 that it can receive a cell.

Upon receipt of the information on the cell reception availableness from the UST 21, the UMT 10-2 transmits a cell to the multiple interface module 400 through the UTOPIA bus 50 together with a control signal defined in the UTOPIA.

Upon receipt of the cell together with the control signal, the UST 21 of the transmission cell interface unit 40-2 stores the received cell in the first and second transmission FIFOs 22 and 23. After the cell is completely stored, the first and second transmission FIFOs 22 and 23 transmit to the UMTs 24 and 25 information that there is a cell to be transmitted.

Upon receipt of the transmission cell information, the UMTs 24 and 25 respectively inquire of the USTs 20-3 and 30-3 of the physical layer boards 200 and 300 through the UTOPIA buses 51 and 52 as to whether they can receive a cell.

The USTs 20-3 and 30-3 of the physical layer boards 200 and 300 checks whether the physical layer processing units 20-1 and 30-1 can receive a cell and informs the UMTs 24 and 25 that cell reception is available.

Upon receipt of the cell reception availableness information from the USTs 20-3 and 30-3, the UMTs 24 and 25 transmit to the physical layer boards 200 and 300 through the UTOPIA buses 51 and 52 the cell together with a proper control signal defined in the UTOPIA.

Accordingly, the USTs 20-3 and 30-3 of the physical layer boards 200 and 300 receive the cell together with the control signal and transmits them to the physical layer processing units 20-1 and 30-1. Then, the physical layer processing units 20-1 and 30-1 processes the received cell and outputs it to the subscriber terminal 500 through the cables 53 and 54.

By doing that, one cycle of cell transmission is completed, and if there is a cell to be received thereafter, the above processes are repeatedly performed.

2) Cell Transmission from the Physical Layer to the ATM Layer Board

The UMRs 11 and 12 of the multiple interface unit 40 requests from the USRs 20-2 and 30-2 of the physical layer boards 200 and 300 through each UTOPIA bus 51 and 52, an information as to whether they can transmit a cell.

The USRs 20-2 and 30-2 check whether there is a cell to be transmitted in the physical layer processing units 20-1 and 30-1, and if there is a transmission cell, the USRs 20-2 and 30-2 transmits to the UMRs 11 and 12 information that cell transmission is available.

Upon receiving the cell transmission availableness information from the USRs 20-2 and 30-2, the UMRs 11 and 12 transmit a control signal defined in the UTOPIA to the USRs 20-2 and 30-2 through the UTOPIA buses 51 and 52.

Upon receiving the control signal, the USRs 20-2 and 30-2 transmit the cell to the UMRs 11 and 12 through the UTOPIA buses 51 and 52 according to a timing requested by the corresponding control signal. The transmitted cell is stored in the first and second reception FIFOs 13 and 14.

At this time, the UMR 10-3 of the ATM layer board 100 inquires of the USR 16 of the reception cell interface unit 40-1 through the UTOPIA bus 50 whether it can transmit a cell. Then, the USR 16 checks whether there is a cell to be transmitted in the first and second reception FIFOs 13 and 14 and transmits cell transmission availableness information to the UMR 10-3.

Upon receiving the cell transmission availableness information from the USR 16, the UMR 10-3 transmits a control signal to the USR 16. Then, upon receiving the control signal, the USR 16 transmits a read signal to the first and second FIFOs 13 and 14 so that the cell stored in the first and second FIFOs 13 and 14 can be outputted to the multiplexer 15.

At this time, the duplicating controller 41 receives the status signals of the physical layer boards 200 and 300 from the physical layer processing units 20-1 and 30-1 and generates a board select signal (SEL).

For example, when the physical layer board 200 is in an alarm state and the physical layer board is in a normal state, the duplicating controller 41 outputs a low level (logic ‘0’) board select signal. Meanwhile, when the physical layer board 200 is in a normal state and the physical layer board 300 is in an alarm state, the duplicating controller 41 outputs a high level (logic ‘1’) board select signal (SEL).

Then, the multiplexer 15 selects a cell outputted from the first and second FIFOs 13 and 14 according to a level of the board select signal (SEL) outputted from the duplicating controller 41 and outputs it to the USR 16, and the USR 16 transmits the cell outputted from the multiplexer 15 to the UMR 10-3 of the ATM layer board 100 through the UTOPIA bus 50 according to the timing of the control signal, so that the UMR 10-3 transmits the received cell to the ATM layer processing unit 10-1.

By doing that, one cycle of cell reception is terminated, and if there exists a cell to be received thereafter, the above processes are repeatedly performed.

FIG. 5 is a drawing illustrating a physical layer duplicating apparatus of an ATM exchange in accordance with a second embodiment of the present invention, in which the multiple interface module 400 is inserted in the ATM layer board 100.

The physical layer duplicating apparatus of an ATM exchange in accordance with a second embodiment of the present invention has the same operation with the first embodiment of FIG. 2.

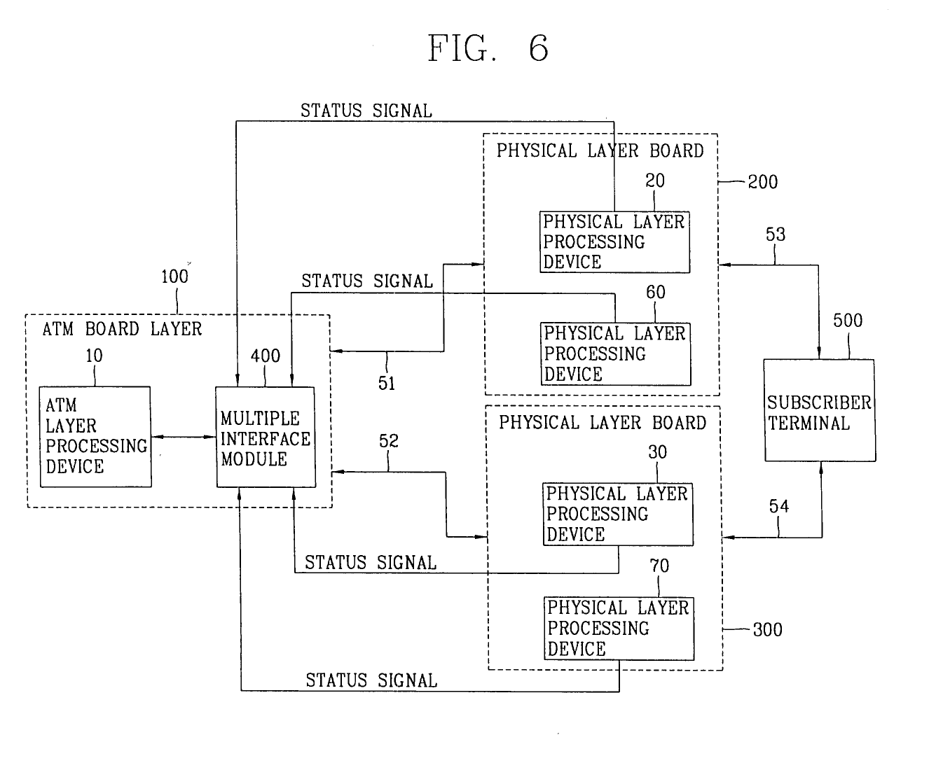

FIG. 6 is a drawing illustrating a physical layer duplicating apparatus of an ATM exchange in accordance with a third embodiment of the present invention;

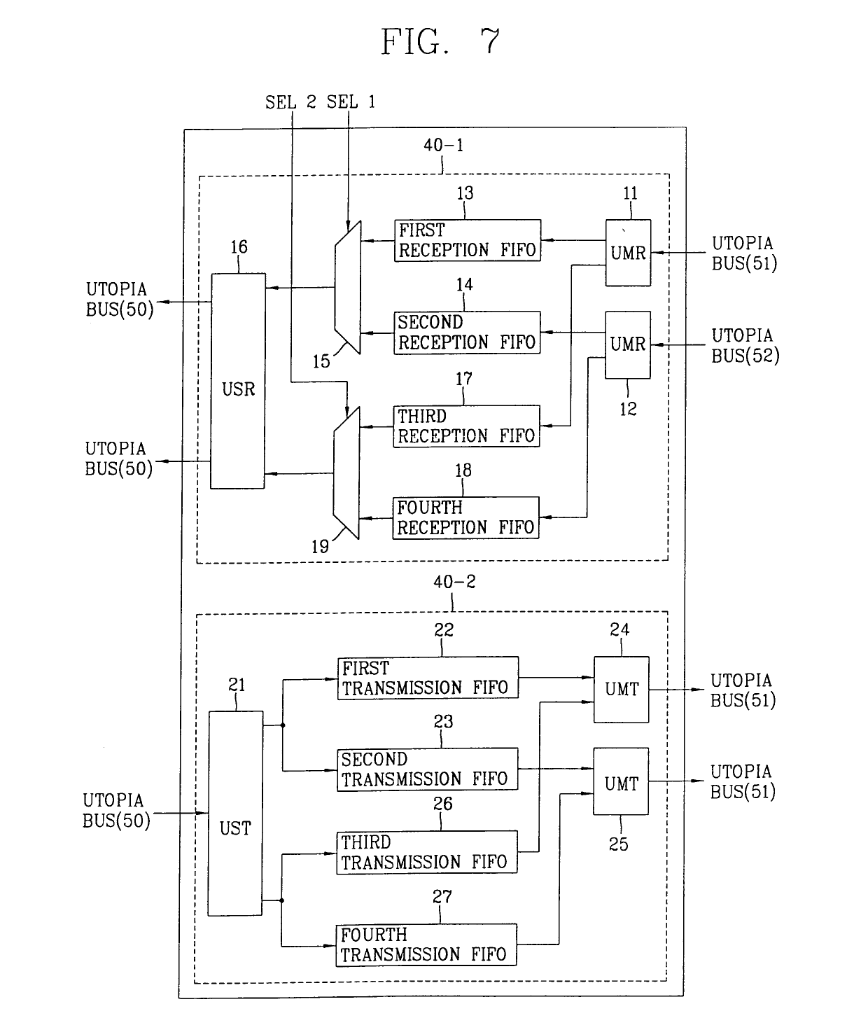

As shown in FIG. 7, a plurality of physical layer devices, for example, two physical layer processing devices, are disposed in each of the physical layer 200 and 300, and in such a case, a duplicating operation and cell transmission/reception can be smoothly performed.

That is, as shown in FIG. 6, when the physical layer processing devices (60), (70) are additionally connected in the physical layers 200 and 300, only the constructions of the reception cell interface unit 40-1 and the transmission cell interface unit 40-2 are changed.

The reception cell interface unit 40-1 includes third and fourth FIFOs 17 and 18 and a multiplexer 19 in addition to the first and second reception FIFOs 13 and 14 and the multiplexer 15. The transmission cell interface unit 40-2 includes third and fourth transmission buffers 26 and 27 in addition to the first and second transmission FIFOs 22 and 23.

Thus, the multiplexers 15 and 19 can transmit a cell outputted from the optimum physical layer board 200 or 300 to the ATM layer board 100 according to the board select signals SEL1 and SEL2.

As so far described, the physical layer duplicating apparatus of an ATM exchange has the following advantages.

That is, for example, by having the duplicated physical layer board and the multiple interface module for interfacing cell transmission between the duplicated physical layers and the ATM layer board, the single corresponding type interface specification pursued by the UTOPIA bus is satisfied and several physical layer boards can be accommodated in a series of communication cycle.

In addition, by providing the duplicated physical layer board, if a trouble occurs in an arbitrary physical layer board, a cell transmission/reception is normally performed through a different physical layer board. Thus, a communication service can be provided smoothly to a subscriber and a reliability of the overall ATM exchange can be improved.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A physical layer duplicating apparatus of an ATM exchange comprising:
first and second physical layer boards connected to a subscriber terminal;
an ATM layer board; and
a multiple interface module for interfacing a cell transmission between the ATM layer board and first and second physical layer boards.

2. The apparatus of claim 1, wherein the multiple interface module receives a cell from the ATM layer board through first UTOPIA bus and transmits the cell equally to the first and second physical layer boards through second and third physical layer boards.

3. The apparatus of claim 2, wherein the multiple interface module performs a slave function of the first UTOPIA bus.

4. The apparatus of claim 1, wherein the multiple interface module receives a cell from the first and second physical layer boards through the second and third UTOPIA buses and selectively transmits the cell to the ATM layer board according to status information of the first and second physical layer boards.

5. The apparatus of claim 4, wherein the multiple interface module performs a master function of the second and third UTOPIA buses.

6. The apparatus of claim 1, wherein the multiple interface module comprises:
a duplicating controller for receiving a status signal from the first and second physical layer boards and outputting a board select signal to select an optimum physical layer board; and
a multiple interface unit for selectively transmitting cells received from the first and second physical layer boards to the ATM layer board according to the board select signal.

7. The apparatus of claim 6, wherein the multiple interface unit comprises:
a transmission cell interface unit for outputting the cell transmitted from the ATM layer board to the first and second physical layer boards; and
a reception cell interface unit for selectively outputting the cells received from the first and second physical layer board to the ATM layer board according to the board select signal.

8. The apparatus of claim 7, wherein the transmission cell interface unit comprises:
a UTOPIA slave transmission (UST) unit for receiving a transmission cell of the ATM layer board inputted through the first UTOPIA bus;
first and second FIFOs for storing the cell received by the UST; and
first and second UTOPIA master transmission (UMT) units for transmitting the cell stored in the first and second transmission FIFOs to the first and second physical layer boards through the second and third UTOPIA buses.

9. The apparatus of claim 7, wherein the reception cell interface unit comprises:
first and second UTOPIA master receipt (UMR) units for receiving transmission cells of the first and second physical layer boards through the second and third UTOPIA buses;
first and second reception FIFOs for storing the cells received from the first and second UMRs;
a multiplexer for selectively outputting the cells stored in the first and second reception FIFOs according to the board select signal; and
an UTOPIA slave receipt (USR) units for outputting the cell outputted from the multiplexer to the ATM layer board through the first UTOPIA bus;

10. The apparatus of claim 1, wherein the multiple interface module can be inserted in the ATM layer board.

11. A physical layer duplicating apparatus of an ATM exchange comprising:
first and second physical layer boards connected to a subscriber terminal;
an ATM layer board; and
a multiple interface module for interfacing a cell transmission between the ATM layer board and first and second physical layer board through an independent UTOPIA bus;
wherein the multiple interface module comprising:
a duplicating controller for receiving a status signal from first and second physical layer boards and outputting a board select signal to select an optimum physical layer board; and
a multiple interface unit for selectively transmitting a cell transmitted from first and second physical layer boards to the ATM layer board according to the board select signal.

12. The apparatus of claim 11, wherein the multiple interface unit comprises:
a transmission cell interface unit for outputting a cell received from the ATM layer board to the first and second physical layer boards; and
a reception cell interface unit for selectively outputting cells received from the first and second physical layer boards to the ATM layer board according to a board select signal.

13. The apparatus of claim 12, wherein the transmission cell interface unit comprises:
a UTOPIA slave transmission (UST) unit for receiving a transmission cell of the ATM layer board inputted through first UTOPIA bus;
first and second FIFOs for storing the cell received by the UST; and
first and second UTOPIA master transmission (UMT) units for transmitting the cell stored in the first and second transmission FIFOs to the first and second physical layer boards through second and third UTOPIA buses.

14. The apparatus of claim 12, wherein the reception cell interface comprises:
first and second UTOPIA master receipt (UMR) units for receiving transmission cells of the first and second physical layer boards through the second and third UTOPIA buses;
first and second reception FIFOs for storing the cells received from the first and second UMRs;
a multiplexer for selectively outputting the cells stored in the first and second reception FIFOs according to the board select signal; and
an UTOPIA slave receipt (USR) units for outputting the cell outputted from the multiplexer to the ATM layer board through the first UTOPIA bus;

15. The apparatus of claim 11, wherein the multiple interface module can be inserted in the ATM layer board.

16. A physical layer duplicating method of an ATM exchange of a physical layer duplicating apparatus of the ATM exchange having a multiple interface module connected between an ATM layer board and first and second physical layer board through a UTOPIA bus, comprising the steps of:
receiving a cell from the ATM layer board through first UTOPIA bus and equally transmitting the cell to first and second physical layer boards through second and third UTOPIA buses; and
receiving cells from the first and second physical layer boards through the second and third UTOPIA buses and selectively transmitting them to the ATM layer board according to the state of the first and second physical layer boards.

17. The method of claim 16, wherein the multiple interface module is inserted in the ATM layer board or installed outside the ATM layer board.

18. The method of claim 16, wherein the selective transmission step comprises:
receiving cells from the first and second physical layer boards;
receiving board status signals of the first and second physical layer boards;
generating a board select signal on the basis of the received board status signal; and
transmitting the cell received from the first or the second physical layer board to the ATM layer board according to the generated board select signal.

19. The method of claim 16, wherein the multiple interface module performs a slave function of first UTOPIA bus and a master function of second and third UTOPIA buses.
